(19) United States
(12) Patent Application Publication
(10) Pub. No.: US 2026/0002884 A1
(43) Pub. Date: Jan. 1, 2026

(54) METHOD AND SYSTEM FOR DIAGNOSING CREEP DAMAGE AND EVALUATING SERVICE LIFE OF DISSIMILAR STEEL WELDED JOINT BASED ON QUANTITATIVE MICROSCOPIC CHARACTERISTICS

(71) Applicant: China Special Equipment Inspection & Research Institute, Beijing (CN)

(72) Inventors: Chang CHE, Beijing (CN); Jianming YU, Beijing (CN); Xinzhong CHEN, Beijing (CN); Dong AN, Beijing (CN); Jie LIU, Beijing (CN); Qingchuan PAN, Beijing (CN); Xiaowei LIAO, Beijing (CN)

(21) Appl. No.: 19/199,799

(22) Filed: May 6, 2025

(30) Foreign Application Priority Data
Jun. 27, 2024 (CN) 202410841223.4

(51) Int. Cl. G01N 21/88; G01N 21/95

(52) U.S. Cl. CPC G01N 21/8851; G01N 21/95; G01N 2021/8887; G01N 2201/126

(57) ABSTRACT

A method and system for diagnosing a creep damage and evaluating service life of a dissimilar steel welded joint based on quantitative microscopic characteristics are disclosed and relate to the field of welding damage detection. The method includes: acquiring first experimental data of the dissimilar steel welded joint; quantitatively processing the first experimental data to obtain first quantitative characteristic parameters including a hole size, a volume fraction, and a precipitate size; acquiring second experimental data of the dissimilar steel welded joint; quantitatively processing the second experimental data to obtain second quantitative characteristic parameters including a grain size, a geometric dislocation density, a grain boundary angle, a recrystallization fraction, a recovered grain ratio, and a deformed grain ratio; and determining a current life stage and a remaining creep life of the dissimilar steel welded joint based on the first and second quantitative characteristic parameters.

### CROSS-REFERENCE TO RELATED APPLICATION

This patent application claims the benefit and priority of Chinese Patent Application No. 202410841223.4 filed with the China National Intellectual Property Administration on Jun. 27, 2024, the disclosure of which is incorporated by reference herein in its entirety as part of the present application.

### TECHNICAL FIELD

The present disclosure relates to the technical field of welding damage detection, and in particular to a method and system for diagnosing a creep damage and evaluating a service life of a dissimilar steel welded joint based on quantitative microscopic characteristics.

### BACKGROUND

In order to improve the efficiency of thermal power generation and save fossil fuels, many countries are developing ultra super critical (USC) thermal power generating units with steam temperatures as high as 600° C. or above. In recent years, a new generation of heat-resistant steels such as HR3C austenitic steel and T92 ferritic steel have been developed for use in high-temperature components of USC boilers. Generally speaking, high-temperature parts of heating surface tubes of power station boilers are often made of austenitic stainless steel, while relatively low-temperature parts are generally made of martensite heat-resistant steel from the economic point of view. Therefore, there are many dissimilar metal welded joints, for example, T92/HR3C, in the USC boilers. Most of these dissimilar steel joints are exposed to high temperatures and high pressures for a long time, and hence are accident-prone parts in operation of the boilers due to their very harsh conditions of use. Creep failure is the most common failure of high-temperature service components. Therefore, a creep damage diagnosis and remaining life prediction for the dissimilar steel welded joints have currently become one of the urgent problems to be solved in power plants.

For ferrite/austenite dissimilar welded joints, the creep strength of nickel-based alloy and austenite-side base metal of welds is higher than that of ferritic steel, and thus the ferrite side becomes the weakest link of the whole joint during service. In particular, a ferrite-side heat affected zone becomes the area of the joint first to be damaged due to the most severe tissue aging. Studies have shown that T92/HR3C steel, when in service at the power plants, fails and ruptures in a fine-grain heat affected zone of T92, which is a weaker link in the creep process.

A creep damage is a key factor that affects material performance and structural integrity in high-temperature working environments. Especially in the energy industry, such as electric power plants and petrochemical facilities, materials are susceptible to creep phenomena when working under high-temperature and high-stress conditions for a long period of time. This slow and continuous deformation process may lead to the decline of material performance, and even lead to a sudden structural damage, bringing safety risks and economic losses. At present, methods used for diagnosing creep damages, such as a microstructure analysis and physical property testing, often have limitations in accuracy and efficiency. These methods may require a significant amount of time and resources and have limited effectiveness in the detection of early damages. Therefore, for dissimilar steel welded joints, especially T92/HR3C dissimilar steel welded joints, it is difficult for a traditional method for quantitatively diagnosing a creep tissue damage to adequately reveal the full picture of the creep damage due to their complex microstructural variations at high temperatures, and thus creep damage monitoring results obtained are inaccurate and unreliable. Therefore, a creep damage diagnosis of such materials requires a more refined and comprehensive approach to ensure their reliability and safety under extreme operating conditions.

Based on this, how to provide a more accurate and reliable method for quantitatively diagnosing a creep tissue damage and evaluating the service life of a dissimilar steel welded joint to determine the current life stage and the remaining creep life of the dissimilar steel welded joint is a technical problem to be solved urgently in this field.

### SUMMARY

The present disclosure intends to provide a method and system for quantitatively diagnosing a creep damage and evaluating a service life of a dissimilar steel welded joint, which can effectively improve the accuracy in diagnosing a creep tissue damage to the dissimilar steel welded joint.

In order to achieve the above intention, the present disclosure provides the following solutions.

In a first aspect, the present disclosure provides a method for quantitatively diagnosing a creep damage and evaluating service life of a dissimilar steel welded joint, including:
acquiring first experimental data of the dissimilar steel welded joint; the first experimental data being creep rupture images after a creep rupture occurs when an accelerated creep rupture experiment is carried out on the dissimilar steel welded joint, and the creep rupture image including a tissue aging image and a precipitate image;
quantitatively processing the first experimental data to obtain first quantitative characteristic parameters; the first quantitative characteristic parameters including a hole size, a volume fraction, and a precipitate size in the creep rupture image;
acquiring second experimental data of the dissimilar steel welded joint; the second experimental data being electron back scatter diffraction (EBSD) experimental data obtained by performing an EBSD experiment after the creep rupture of the dissimilar steel welded joint;
quantitatively processing the second experimental data to obtain second quantitative characteristic parameters; and the second quantitative characteristic parameters including a grain size, a geometric dislocation density, a grain boundary angle, a recrystallization fraction, a recovered grain ratio, and a deformed grain ratio;
determining a current life stage and a remaining creep life of the dissimilar steel welded joint based on the first quantitative characteristic parameters and the second quantitative characteristic parameters.

In an embodiment, acquiring the first experimental data of the dissimilar steel welded joint specifically includes:
carrying out the accelerated creep rupture experiment based on the dissimilar steel welded joint to obtain a creep rupture sample;
observing the creep rupture sample using an optical microscope, and outputting the tissue aging image of the creep rupture sample; and
observing the creep rupture sample using a scanning electron microscope, and outputting the precipitate image of the creep rupture sample.

In an embodiment, prior to observing the creep rupture sample using the optical microscope, and outputting the tissue aging image of the creep rupture sample, the method further includes:
sanding and polishing a sample surface in a creep rupture region of the creep rupture sample to obtain a sanded and polished creep rupture sample;
placing the sanded and polished creep rupture sample in an erosion solution for erosion to obtain an eroded creep rupture sample; and
rinsing and then drying the eroded creep rupture sample to obtain a rinsed creep rupture sample, the rinsed creep rupture sample being used as the creep rupture sample observed by the optical microscope and the scanning electron microscope.

In an embodiment, prior to quantitatively processing the first experimental data to obtain the first quantitative characteristic parameters, the method further includes:
performing automatic threshold segmentation processing, edge detection processing, and image denoising processing on the creep rupture images sequentially by using Image-J software to obtain preprocessed creep rupture images as the first experimental data.

In an embodiment, quantitatively processing the first experimental data to obtain the first quantitative characteristic parameters specifically includes:
determining a size and a volume fraction of each hole in the tissue aging image by using Image-J software;
determining a type of each precipitate in the precipitate image according to the precipitate image; and
determining a size of each type of precipitate in the precipitate image by using the Image-J software.

In an embodiment, quantitatively processing the second experimental data to obtain the second quantitative characteristic parameters specifically includes:
importing the EBSD experimental data into Channel 5 software, and outputting the grain size, the geometric dislocation density, the grain boundary angle, the recrystallization fraction, the recovered grain ratio, and the deformed grain ratio corresponding to the EBSD experimental data by using the Channel 5 software.

In an embodiment, prior to acquiring the second experimental data of the dissimilar steel welded joint, the method further includes:
sanding a sample surface of the creep rupture sample to obtain a sanded creep rupture sample; and
electropolishing the sanded sample surface of the creep rupture sample to obtain an electropolished creep rupture sample as the creep rupture sample for the EBSD experiment.

In an embodiment, determining the current life stage and the remaining creep life of the dissimilar steel welded joint based on the first quantitative characteristic parameters and the second quantitative characteristic parameters specifically include:
establishing a relation curve between a characteristic parameter and creep life loss of the dissimilar steel welded joint based on the first quantitative characteristic parameters and the second quantitative characteristic parameters; and
determining a current life stage and remaining creep life of the dissimilar steel welded joint based on the relation curve between the characteristic parameter and the creep life loss of the dissimilar steel welded joint.

In a second aspect, the present disclosure provides a system for quantitatively diagnosing a creep damage and evaluating service life of a dissimilar steel welded joint, the system including:
a first experimental data acquisition module configured to acquire first experimental data of the dissimilar steel welded joint; the first experimental data being creep rupture images after a creep rupture occurs when an accelerated creep rupture experiment is carried out on the dissimilar steel welded joint, and the creep rupture images including a tissue aging image and a precipitate image;
a first quantitative characteristic parameter acquisition module configured to quantitatively process the first experimental data to obtain first quantitative characteristic parameters; the first quantitative characteristic parameters including a hole size, a volume fraction, and a precipitate size in the creep rupture image;
a second experimental data acquisition module configured to acquire second experimental data of the dissimilar steel welded joint; the second experimental data being EBSD experimental data obtained by performing an EBSD experiment after the creep rupture of the dissimilar steel welded joint;
a second quantitative characteristic parameter acquisition module configured to quantitatively process the second experimental data to obtain second quantitative characteristic parameters; and the second quantitative characteristic parameters including a grain size, a geometric dislocation density, a grain boundary angle, a recrystallization fraction, a recovered grain ratio, and a deformed grain ratio;
a diagnosis module configured to determine a current life stage and remaining creep life of the dissimilar steel welded joint based on the first quantitative characteristic parameters and the second quantitative characteristic parameters.

According to the specific embodiments provided by the present disclosure, the present disclosure discloses the following technical effects.

The present disclosure provides the method for quantitatively diagnosing the creep damage and evaluating the service life of the dissimilar steel welded joint. By carrying out the accelerated creep rupture experiment and the EBSD experiment on the dissimilar steel welded joint, and collecting the creep rupture images and the EBSD experimental data after the experiments, the hole size, the volume fraction and the precipitate size in the creep rupture image, and the parameters such as the grain size, the geometric dislocation density, the grain boundary angle, the recrystallization fraction, the recovered grain ratio and the deformed grain ratio, can be quantitatively analyzed, such that the two types of the parameters (i.e., the first quantitative characteristic parameters and the second quantitative characteristic parameters) obtained by analysis in both of the accelerated creep rupture experiment and the EBSD experiment are combined to determine the current life stage and the remaining creep life of the creep tissue of the dissimilar steel welded joint, thereby improving the accuracy in diagnosing the creep tissue damage to the dissimilar steel welded joint. In addition, the method is widely applicable to dissimilar steel welded joints of new materials, long-term service materials, and materials undergoing high-temperature and high-pressure accelerated creep ruptures, thus is universally applicable and can provide critical information for early diagnosis and effective management of the creep damage.

### BRIEF DESCRIPTION OF THE DRAWINGS

In order to illustrate the technical solutions in the embodiments of the present disclosure or conventional technology more clearly, a brief introduction to the drawings necessary for the embodiments will be provided below. Apparently, the drawings in the following description are merely some of the embodiments of the present disclosure, and those of ordinary skill in the art can also obtain other drawings according to these drawings without involving any inventive effort.

FIG. 1 is a flow chart of a method for quantitatively diagnosing a creep damage and evaluating a service life of a dissimilar steel welded joint according to Embodiment 1 of the present disclosure;

FIG. 2 is a schematic diagram of a hole volume fraction as a function of time according to Embodiment 1 of the present disclosure;

FIG. 3 is a schematic diagram of a hole size as a function of time according to Embodiment 1 of the present disclosure;

FIG. 4 is a schematic diagram of a Laves-phase size as a function of time according to Embodiment 1 of the present disclosure;

FIG. 5 is a schematic diagram of an M₂₃C₆-phase size as a function of time according to Embodiment 1 of the present disclosure;

FIG. 6 is a schematic diagram of a grain size as a function of time according to Embodiment 1 of the present disclosure;

FIG. 7 is a schematic diagram of a dislocation density as a function of time according to Embodiment 1 of the present disclosure;

FIG. 8 is a schematic diagram of a grain boundary angle as a function of time according to Embodiment 1 of the present disclosure; and

FIG. 9 is a schematic diagram of proportions of three grain types as a function of time according to Embodiment 1 of the present disclosure.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the embodiments described are merely a part of rather than all of the embodiments of the present disclosure. Based on the embodiments in the present disclosure, all other embodiments that would have been obtained by those of ordinary skill in the art without any inventive effort shall fall within the protection scope of the present disclosure.

An objective of the present disclosure is to provide a method and system for quantitatively diagnosing a creep damage and evaluating a service life of a dissimilar steel welded joint, which are applicable to a damage diagnosis of any metal welded joint in the creep process, can determine the current life stage and the remaining creep life of the dissimilar steel welded joint, thereby effectively improving the accuracy in diagnosing a creep tissue damage to the dissimilar steel welded joint.

In order to make the objectives, features and advantages of the present disclosure more clearly understood, the present disclosure will be further described in detail below with reference to the accompanying drawings and specific embodiments.

### Embodiment 1

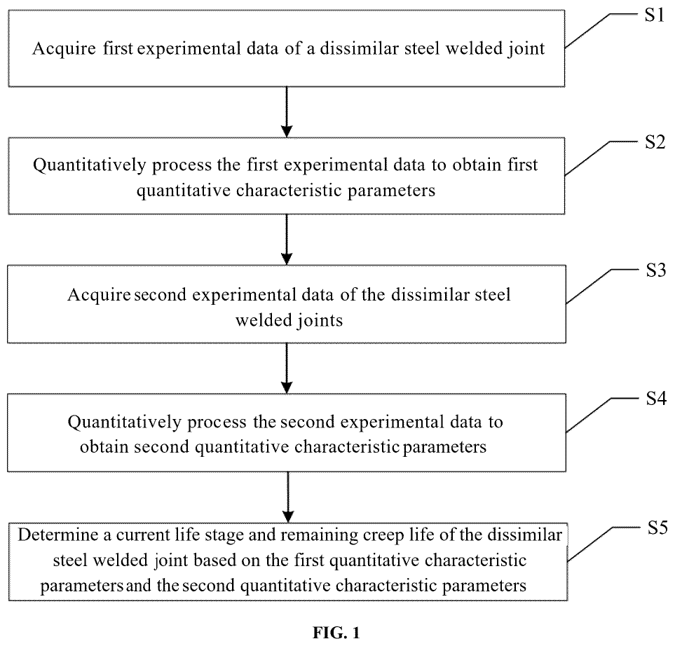

As shown in FIG. 1, a method for quantitatively diagnosing a creep damage and evaluating a service life of a dissimilar steel welded joint in this embodiment includes the following steps S1-S5.
Step S1: first experimental data of the dissimilar steel welded joint are acquired. The dissimilar steel welded joint is a joint welded with dissimilar steel and is made of a new material, a long-term service material, or a material with accelerated creep rupture due to a high-temperature and high-pressure. The first experimental data are creep rupture images after a creep rupture occurs when an accelerated creep rupture experiment is carried out on the dissimilar steel welded joint, and the creep rupture images include a tissue aging image and a precipitate image.
Step S2: the first experimental data are quantitatively processed to obtain first quantitative characteristic parameters. The first quantitative characteristic parameters include a hole size, a volume fraction, and a precipitate size in the creep rupture image.
Step S3: second experimental data of the dissimilar steel welded joint are acquired. The second experimental data are EBSD experimental data obtained by performing an EBSD experiment after the creep rupture of the dissimilar steel welded joint.
Step S4: the second experimental data are quantitatively processed to obtain second quantitative characteristic parameters. The second quantitative characteristic parameters include a grain size, a geometric dislocation density, a grain boundary angle, a recrystallization fraction, a recovered grain ratio, and a deformed grain ratio. The recrystallization fraction refers to the ratio of the volume of recrystallization occurring in a material to the total volume of the material, also known as a recrystallized grain ratio.
Step S5: a current life stage and a remaining creep life of the dissimilar steel welded joint are determined based on the first quantitative characteristic parameters and the second quantitative characteristic parameters.

In this embodiment, after Step S5, the method further includes the following steps:
determining whether a replacement condition is met according to the remaining creep life of the dissimilar steel welded joint;
replacing the dissimilar steel welded joint in response to that the replacement condition is met;
determining whether a maintenance condition is met in response to that the replacement condition is not met; and
conducting maintenance measures to the dissimilar steel welded joint in response to that the maintenance condition is met.

In this embodiment, the replacement condition is that the remaining creep life of the dissimilar steel welded joint is less than or equal to a first remaining life threshold, and the maintenance condition is that the remaining creep life of the dissimilar steel welded joint is greater than the first remaining life threshold and less than or equal to a second remaining life threshold; where the first remaining life threshold is less than the second remaining life threshold.

In this embodiment, the maintenance measures includes: ensuring that the operating pressure of the dissimilar steel welded joint does not exceed the preset pressure and the operating temperature of the dissimilar steel welded joint does not exceed the preset temperature; shortening the inspection cycle of the dissimilar steel welded joint, and performing periodic inspections on the dissimilar steel welded joint with the shortened inspection cycle; where the periodic inspections include at least one of nondestructive testing and tube cutting performance test, the tube cutting performance test includes at least one of metallographic structure examination and mechanics performance testing.

In this embodiment, the first remaining life threshold is less than or equal to 0.2T, and the second remaining life threshold is greater than 0.2T and less than or equal to 0.5T, where T is a creep life of the dissimilar steel welded joint.

In this embodiment, acquiring the first experimental data of the dissimilar steel welded joint in Step S1 specifically includes:
Step S11: carrying out the accelerated creep rupture experiment based on the dissimilar steel welded joint to obtain a creep rupture sample;
Step S12: observing the creep rupture sample using an optical microscope, and outputting the tissue aging image of the creep rupture sample; and
Step S13: observing the creep rupture sample using a scanning electron microscope, and outputting the precipitate image of the creep rupture sample.

In this embodiment, prior to observing the creep rupture sample using the optical microscope, and outputting the tissue aging image of the creep rupture sample in Step S12, the method further includes:
Step S111: sanding and polishing a sample surface in a creep rupture region of the creep rupture sample to obtain a sanded and polished creep rupture sample;
Step S112: placing the sanded and polished creep rupture sample in an erosion solution for erosion to obtain an eroded creep rupture sample; and
Step S113: rinsing and then drying the eroded creep rupture sample to obtain a rinsed creep rupture sample as the creep rupture sample observed by the optical microscope and the scanning electron microscope.

In this embodiment, prior to quantitatively processing the first experimental data to obtain the first quantitative characteristic parameters in Step S2, the method further includes:

Step S14: performing automatic threshold segmentation processing, edge detection processing, and image denoising processing on the creep rupture image sequentially by using Image-J software to obtain a preprocessed creep rupture image as the first experimental data to be quantitatively processed.

In this embodiment, quantitatively processing the first experimental data to obtain the first quantitative characteristic parameters in Step S2 specially includes:
S21: determining a size and a volume fraction of each hole in the tissue aging image by using Image-J software;
S22: determining a type of each precipitate in the precipitate image according to the precipitate image; and
S23: determining a size of each type of precipitate in the precipitate image by using the Image-J software.

In this embodiment, quantitatively processing the second experimental data to obtain the second quantitative characteristic parameters in Step S4 specially includes:
importing the EBSD experimental data into Channel 5 software, and outputting the grain size, the geometric dislocation density, the grain boundary angle, the recrystallization fraction, the recovered grain ratio, and the deformed grain ratio corresponding to the EBSD experimental data by using the Channel 5 software.

In this embodiment, prior to acquiring the second experimental data of the dissimilar steel welded joint in Step S3, the method further includes:
S24: sanding a sample surface of the creep rupture sample to obtain a sanded creep rupture sample;
S25: electropolishing the sanded sample surface of the creep rupture sample to obtain an electropolished creep rupture sample as the creep rupture sample for the EBSD experiment.

In this embodiment, determining the current life stage and the remaining creep life of the dissimilar steel welded joint based on the first quantitative characteristic parameters and the second quantitative characteristic parameters in Step S5 specifically includes:
S51: establishing a relation curve between a characteristic parameter and creep life loss of the dissimilar steel welded joint based on the first quantitative characteristic parameters and the second quantitative characteristic parameters; and
S52: determining a current life stage and remaining creep life of the dissimilar steel welded joint based on the relation curve between the characteristic parameter and the creep life loss of the dissimilar steel welded joint.

In the following, the specific operation process of this embodiment will be made clearer by way of examples.

In this embodiment, the creep failure process of the dissimilar steel welded joint (especially a martensite/austenite dissimilar welded joint, such as T92/HR3C and other materials) under a high temperature and a high pressure is diagnosed and quantified by computer-aided image processing and data analysis methods. In this embodiment, the key steps include image acquisition, image processing, feature extraction, data analysis and prediction of remaining creep life, and specifically include the following steps.

In step (1), an accelerated creep rupture experiment at 650° C. and 50 MPa is carried out on the welded joint that has been in service for a long time in a power plant until a rupture occurs. A precise temperature and pressure control system is employed to ensure the stability of experimental conditions. Upon completion of the experiment, the position of a creep rupture is accurately recorded, and the rupture is located in a fine-grain zone of a heat affected zone of T92. Subsequently, the microstructural evolution characteristic quantity having an impact on the creep rupture and studied based on the creep damage mechanism is extracted, i.e., the study on the creep damage mechanism shows that the creep damage rupture is mainly caused by microstructural aging in the fine-grain zone of the martensite-steel-side T92 heat affected zone, resulting in creep holes. Microstructural aging characteristics include an increase in a precipitate size, an increase in a grain size, a decrease in a proportion of small-angle grain boundary to form a large-angle grain boundary, a decrease in an average dislocation density, and an increase in a proportion of recrystallization.

In this embodiment, an accelerated creep experiment is carried out on the welded joint at a temperature of 650° C. and a pressure of 50 MPa, where 650° C. and 50 MPa are selected to ensure that a rupture position is in the heat affected zone of T92, which is the same as an actual high-temperature and low-stress service failure position of the power plant, thereby ensuring that the rupture position is in the fine-grain heat affected zone of T92. Herein, the observed position is in the vicinity of the rupture position, and the observed characteristic quantities include the precipitate size, the grain size, a grain boundary angle distribution, an average dislocation density and the recrystallization fraction. Moreover, based on the study of the failure mechanism, a structure characteristic parameter that causes a failure of the dissimilar steel welded joint is quantitatively detected. This quantitative diagnosis provides a new method for evaluating a creep damage and a remaining life of the dissimilar steel welded joint, which is of great significance to the development of material creep performance evaluation.

In step (2), the sample surface near the rupture region before and after the creep rupture are sanded and polished respectively, then eroded with FeCl₃ and HCl solutions for 10-15 seconds, rinsed with alcohol and blown dry.

In this embodiment, sanding and polishing are generally performed by using sandpaper and a polishing machine; where the sanding is progressively performed with coarse sandpapers and then fine sandpapers, generally in the order of 60 meshes, 200 meshes, 400 meshes, 1,000 meshes, 1,500 meshes, and 2,000 meshes; and scratches on the surface are then sanded off by the polishing machine with the aim of making the sample surface flat and smooth for the subsequent microscopic observation and analysis. After sanding and polishing, the surface is cleaned by using solution erosion and alcohol rinsing to better visualize microstructural changes.

In this embodiment, FeCl₃ and HCl solutions may be used as an erosion solution, and other solutions are also available. However, considering that for the T92/HR3C welded joint, the erosion solution prepared from FeCl₃ and HCl solutions has a better effect on corrosion of the sample. Thus, in this embodiment, FeCl₃ and HCl solutions are preferred for erosion of the sample and formulated with the following ratios of reagents: FeCl₃ 1 g, HCl 10 ml, and water 20 ml.

In step (3), the eroded sample is observed under an optical microscope and a scanning electron microscope, and a photographed photo is subjected to image processing by using Image-J software, including the application of image preprocessing technologies such as automatic threshold segmentation, edge detection and denoising, to optimize the image quality, and then quantitative processing is carried out to obtain the hole size, the volume fraction, and the precipitate size.

The optical microscope is configured to take photos of tissue aging in the T92 fine-grain heat affected zone. A photo of the T92 fine-grain heat affected zone containing a precipitate is taken by the scanning electron microscope in a back scattered electron (BSE) mode, with a minimum of 30 photos taken for each specimen at a field-of-view magnification of 10,000 times. Since the main precipitates of a T92/HR3C welded joint after service are M₂₃C₆, Laves, MX, etc., and the M₂₃C₆ and Laves phases have large changes in size and area ratio after a creep rupture, it is determined that these two precipitates may lead to failure ruptures on the T92 side of the welded joint.

Since the sizes of M₂₃C₆ and Laves phases are generally greater than 50 nm, in this embodiment, the precipitates with the sizes greater than 50 nm are firstly screened for statistics by using Image-J software, and then the two precipitates, M₂₃C₆ and Laves, are distinguished by the color of the BSE picture, and quantified.

It should be noted that elements with larger atomic numbers are brighter in the BSE mode of the scanning electron microscope. Laves mainly contains the chemical component W, M₂₃C₆ mainly contains Cr, and MX mainly contains Nb and V. Thus, the Laves phase may be brighter in the BSE mode, and may be bright white in the image; and M₂₃C₆ phase and MX phase are gray in the image, but MX is smaller in size and thus easy to be distinguished.

In this embodiment, since the overgrowth of the sizes of the precipitates Laves and M₂₃C₆ is one of the causes of the material failure rupture, in this embodiment, the precipitates are identified in the BSE mode, and then size screening and statistics are performed by using the Image J software, such that the quantitative statistics can be performed on both of the precipitates Laves and M₂₃C₆ for tissue damage diagnosis and assessment.

In step (4), the sample surface before and after the creep rupture are sanded respectively, and then the sample surface is electropolished with perchloric acid and alcohol for 15 s to remove a surface stress.

In this embodiment, in step (4), the sample surface before and after the creep rupture are sanded with 60-mesh, 200-mesh, 400-mesh, 1,000-mesh, 1,500-mesh, and 2,000-mesh sandpaper sequentially, where the direction of each sanding is perpendicular to the direction of a previous scratch, until the scratches are thin and are in the same direction.

In this embodiment, a solution used for electropolishing may be perchloric acid and alcohol, and other solutions may also be available. However, for this material, an electropolishing solution prepared from the perchloric acid and alcohol solution has a better electropolishing effect. The perchloric acid and alcohol solution is formulated with the following ratio: perchloric acid 10 ml and alcohol 90 ml, the electropolishing voltage is 15 V, and the electropolishing time is 15 s, such that the electropolishing effect is ensured, and then the surface stress can be effectively removed.

In step (5), the electropolished sample is subjected to the EBSD experiment, and experimental data is processed by using Channel 5 software to quantitatively analyze the microstructural characteristics of the material.

In this embodiment, the EBSD experimental data of the sample is first collected and imported into the Channel 5 software. The data are then cleaned to remove noise and non-exponential regions to ensure the accuracy of analysis. The grain size distribution is calculated by means of an analysis tool within the software, which involves identification of grain boundaries and statistics of frequency distribution of grains of all sizes. The grain boundary angle is automatically identified by the software according to orientation differences between the grains. In this process, an angle threshold of 2°-10° is set as a small-angle grain boundary, and an angle greater than 10° is set as a large-angle grain boundary. Subsequently, the software may calculate and count all angles of all identified grain boundaries to form a distribution map of the grain boundary angles. The geometrically necessary dislocations (GND) density values may be estimated by calculating the local orientation gradient, and upon completion of the calculation, the software provides a distribution map and statistic data of the GND values. Finally, by comparing the sizes, orientations and shapes of the grains, the software can identify recrystallized grains, and calculate the recrystallization fraction.

In this embodiment, after the EBSD experiment, it is usually necessary to use professional software such as Channel 5 for data processing. This is mainly because the data generated by the EBSD experiment is very rich and complex, including crystallographic orientations, grain boundaries, and phase information, etc., and these data need to be analyzed and interpreted in detail by the professional software. The Channel 5 software is a powerful tool specifically designed to process and analyze the EBSD data, to provide functions from basic data processing to advanced material characteristic analysis. In this embodiment, Channel 5 is used primarily to determine the parameters, such as the grain size, the geometric dislocation density, the grain boundary angle, the recrystallization fraction, the recovered grain ratio and the deformed grain ratio.

In this embodiment, in step (6), the division of the creep rupture time into 10 stages is achieved by subjecting the post-service material to a durability experiment to obtain the rupture time t, and then dividing the rupture time into 10 time points in an equal proportion, e.g., 0.1 t, 0.2 t, 0.3 t, 0.4 t, 0.5 t, 0.6 t, 0.7 t, 0.8 t, 0.9 t, t, etc., where t is any preset time duration to achieve the division of 10 creep rupture time stages. By a first quantitative testing method based on the first quantitative characteristic parameters and a second quantitative testing method based on the second quantitative characteristic parameters, quantitative statistics are performed on the hole size, the hole volume fraction, the Laves-phase size and the M₂₃C₆ size, as well as the grain size, the dislocation density, the ratios of large and small grain boundary angles, the recovered grain ratio, the recrystallization fraction and the deformed grain ratio, at each time point, and a suitable fitting method is selected to establish a relation curve relevant to the creep time. The effect of predicting the creep stage by one or more microstructural parameters strongly correlated with time can be achieved by means of a fitting equation. The accuracy of prediction can be improved by means of multiple parallel tests.

In this embodiment, since the creep rupture time is divided into 10 stages, in establishing the relation curve between the characteristic parameter and the creep life loss, the quantified parameters are correlated with creep rupture times using Origin software, such that the relation curve between the microstructure and the creep time can be drawn.

In this embodiment, in determining the current life stage of the dissimilar steel welded joint, statistical analysis and curve fitting are carried out by using the Origin software based on corresponding data of the experimental data (such as precipitate size, grain size and grain boundary angle distribution) and creep time, and the fitted curve may be in the form of linear, logarithmic, exponential or other mathematical models. The curve described above is then analyzed, looking in particular for variation trends in parameters that are clearly correlated with the creep life. For example, if a specific microstructural parameter (for example, the precipitate size) is strongly correlated with a decrease in material performance (for example, a decrease in hardness) over time, the change of this parameter may be a key predictor of a material failure.

In this embodiment, in calculating the remaining life, time required to reach a critical damage state is predicted using a relation curve between the characteristic parameter and the creep life loss by inputting the currently measured microstructural parameters (from a new prepared sample or a component in service) into a remaining life prediction model (the remaining life prediction model may be any model in the conventional technology that can predict the remaining life of a device). For example, if it is known that the critical size of a particular precipitate is closely related to the material failure, time to reach this critical size can be predicted according to the current size and growth rate. If the life at a temperature and stress that are different from those of the durability creep experiment in this embodiment is to be calculated, a Larson-Miller parameter model of the material can be combined, which is a model of temperature and time, thereby predicting the remaining life at a desired temperature and stress based on the microstructure.

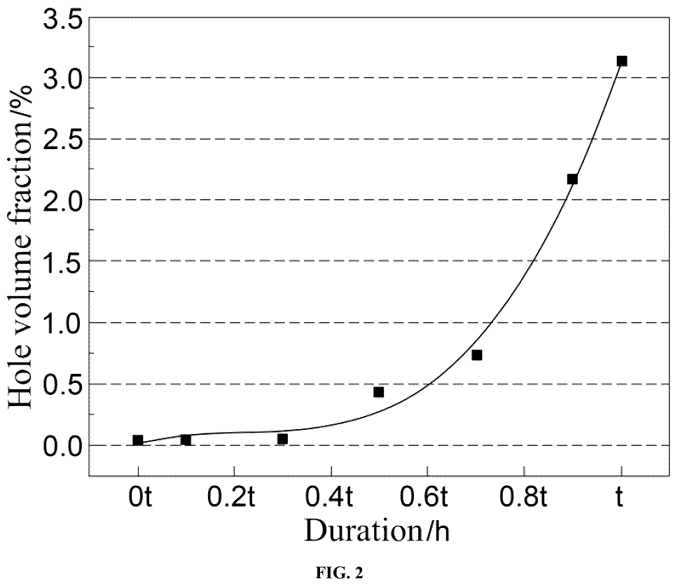

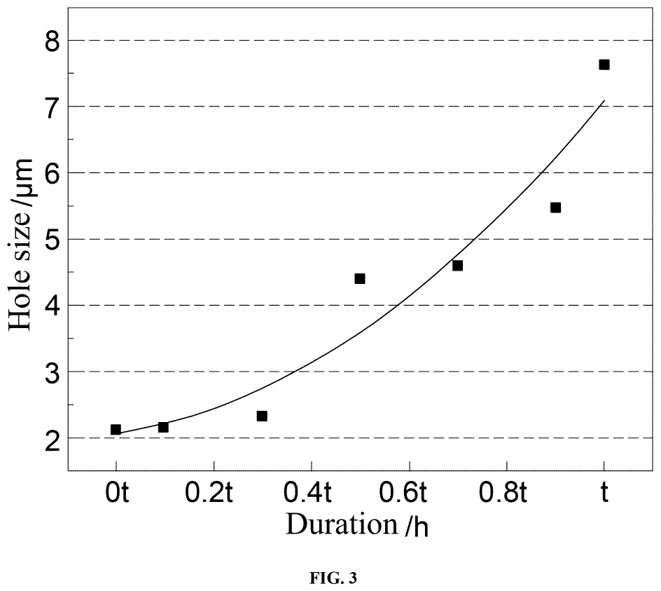

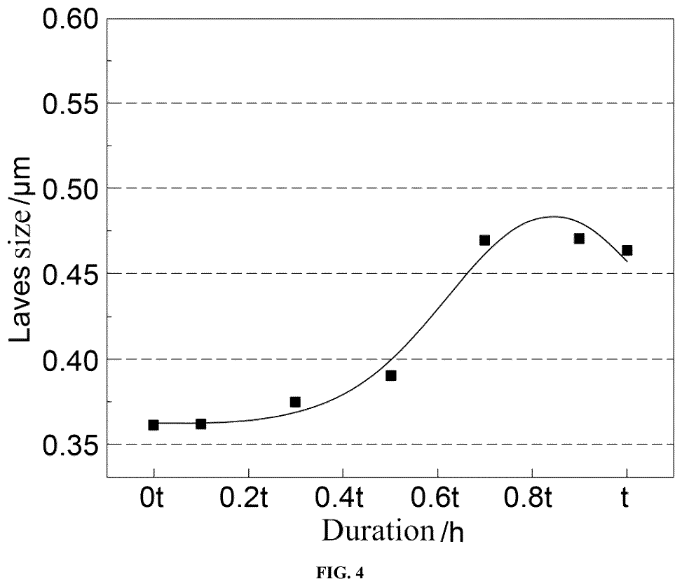

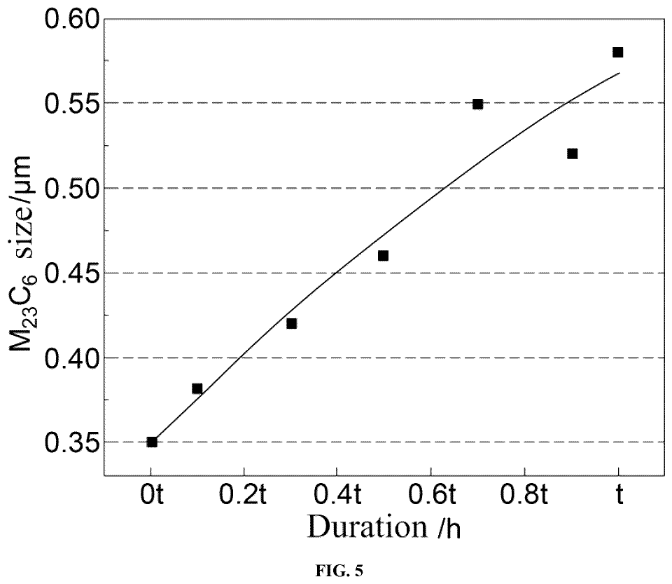

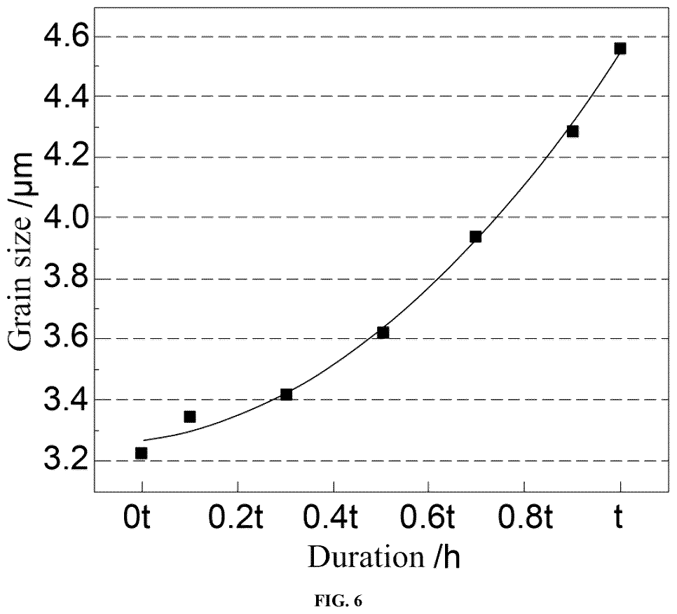

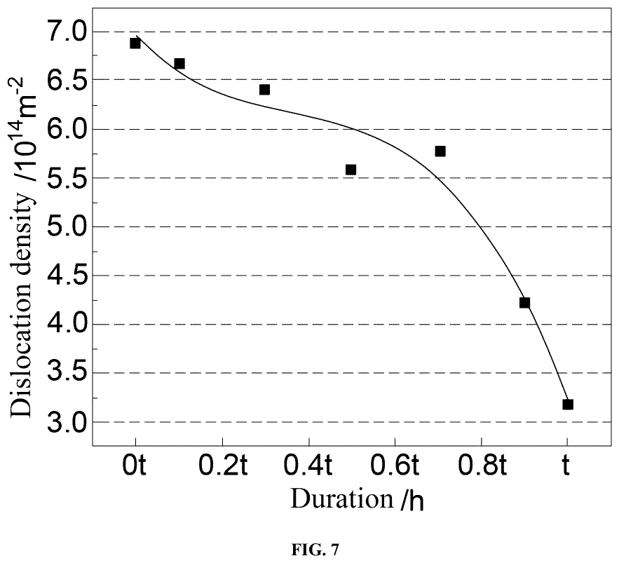

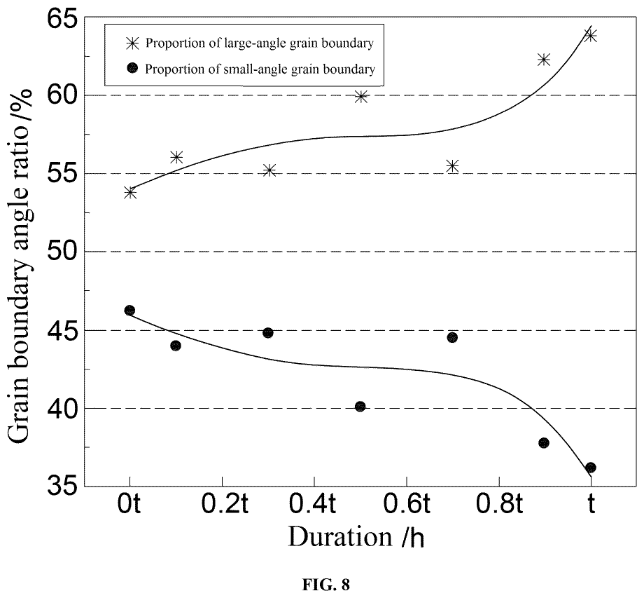

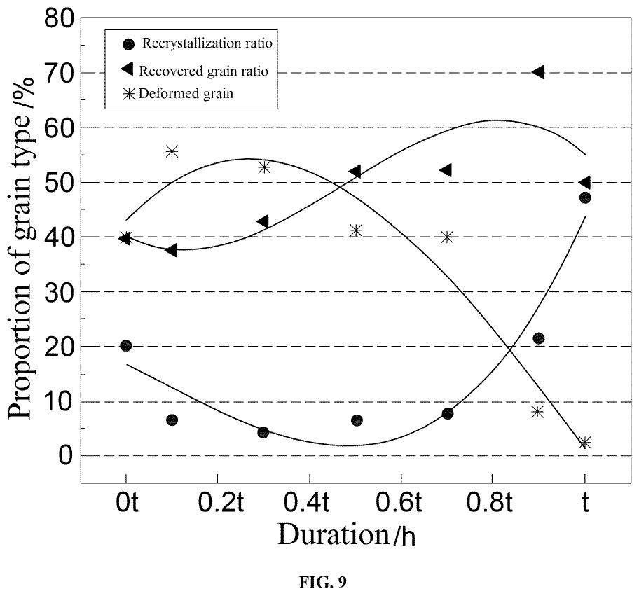

Some experimental results obtained by this method are shown as below. FIG. 2 is a schematic diagram of a hole volume fraction as a function of time; FIG. 3 is a schematic diagram of a hole size as a function of time; FIG. 4 is a schematic diagram of a Laves-phase size as a function of time; FIG. 5 is a schematic diagram of an M₂₃C₆-phase size as a function of time; FIG. 6 is a schematic diagram of a grain size as a function of time; FIG. 7 is a schematic diagram of a dislocation density as a function of time; FIG. 8 is a schematic diagram of a grain boundary angle as a function of time; and FIG. 9 is a schematic diagram of proportions of three grain types including recrystallized grains, recovered grains and deformed grains as a function of time. From FIGS. 2 to 9, the variation laws of different quantized data and creep time can be visualized, and the microstructural parameters that are strongly correlated with time can be obtained by means of fitting. After the creep time reaches 0.7 t, the material is subject to significant hole merging and growth, precipitate coarsening, dislocation density reduction, etc. in this region, which may lead to a decline in material performance and hence a material failure rupture may be more prone to occur after this stage, and after this stage, failure prevention of the material should be strengthened.

In this embodiment, the advanced image processing technology and the detailed quantitative analysis method are adopted to realize an accurate assessment of the creep damage through careful observation and quantification of the microstructural characteristics of actual materials. The optical microscope and the scanning electron microscope are combined for observation, and together with image analysis by the Image-J software, the key damage characteristics in the creep process, such as the precipitate size, the grain size, the grain boundary angle distribution, the average dislocation density and the recrystallization fraction, are accurately quantified. This quantitative analysis means provides a more accurate damage assessment than traditional methods. Therefore, this method focuses on quantitative analysis through various detailed microstructural evolution characteristics to provide a creep damage diagnosis method for a welded joint (T92/HR3C). Its principles and technical framework are universally applicable and can be extended to a wide range of other materials and different industrial application scenarios, thereby providing a technical support for creep damage diagnosis and life prediction of various materials. The method is capable of identifying an early sign of the creep damage at the microscopic level, and thus provides an early warning, which helps to take necessary maintenance or replacement measures in a timely manner to avoid possible device failures, and reduce economic losses and safety risks. In contrast, a traditional method for evaluating a creep damage and a fatigue damage factor focuses only on the change in size of a carbide M₂₃C₆ in the creep damage, and focuses more on life prediction by means of a theoretical and physical model in conjunction with the damage mechanism. However, in the actual service process, various microstructural changes work together, and the various changes, such as changes in the Laves-phase size, the grain size and the dislocation density, may all have a huge impact on the creep process.

In this embodiment, the method for quantitatively diagnosing of a creep damage and evaluating a service life of a dissimilar steel welded joint is actually a complete set of comprehensive technical method for diagnosing a creep damage and predicting a remaining life of a new material and a long-term service material of the dissimilar steel welded joint in a high-temperature and high-pressure environment, including detailed quantification of microstructural evolution characteristics in the creep damage process of the dissimilar steel welded joint, observation by using advanced image processing technologies (including the optical microscope and the scanning electron microscope), image analysis by the Image-J software to quantify key damage characteristic parameters (including the precipitate size, the grain size, the grain boundary angle distribution, the average dislocation density, the recrystallization fraction, etc.), and establishment of correlation between these damage characteristic parameters and the creep life time.

At present, a traditional analysis method for evaluating a damage and remaining life of the ferrite/austenite dissimilar steel welded joint in a power plant mainly focuses on qualitative analysis of a metallographic structure and a comparison of the structures before and after a failure to analyze the degree of damage. This method is highly subjective and cannot reflect the comprehensive performance of each region. However, in this embodiment, the creep damage diagnosis method has the following main advantages.

(1) Enhanced accuracy: in this embodiment, a more comprehensive and in-depth understanding of the creep damage process can be achieved by comprehensively analyzing the microstructural changes, for example in the grain size, the grain boundary angle distribution and the dislocation density, of new materials, long-term service materials and materials with creep due to high-temperature and high-pressure; and this comprehensive analysis provides a more accurate diagnosis of a damage, especially in the early stage of the damage.

(2) Early damage identification: in this embodiment, by quantifying the microstructural changes, subtle changes can be identified in the early stage of creep damage; and early detection helps prevent potential large-scale device failures by taking timely repair or replacement measures.

(3) Wide applicability: this embodiment is not only applicable to specific T92/HR3C dissimilar steel welded joints, but also applicable to diagnosis of creep damages of various other industrial materials, and metal materials working at high temperatures, for example, other types of steels and alloys, especially heat-resistant materials used in the power, petrochemical and other industries; and this makes the method an important tool for material performance evaluation and maintenance decision-making in various industrial applications.

(4) Data-driven decision support: in this embodiment, quantitative data is provided to support more scientific decision-making, such as maintenance planning, a life prediction, and a risk assessment, which can enhance the decision-making capacity of an enterprise in material maintenance and replacement strategy, and improve the operational efficiency and the cost-effectiveness.

(5) Promotion of industry research and development: the development and application of the new method provided by this embodiment can stimulate further industry research and promote the development of materials science and engineering technologies; this method and data results can be used for developing or improving a creep damage prediction model, which can help the power plant predict the life and maintenance needs of critical components, so as to plan maintenance and replacement in advance and reduce the risk of unexpected shutdown.

This embodiment provides the method for quantitatively diagnosing a creep damage and evaluating a service life of a dissimilar steel welded joint, in which advanced quantification technologies and microstructural analysis are combined to accurately assess the degree of damage to the materials in different creep states, including new materials, long-term service materials, and materials with accelerated creep ruptures due to high-temperature and high-pressure. By detailed microstructural evolution characteristic analysis, for example, quantification of these characteristic parameters including the precipitate size, the grain size, the grain boundary angle distribution, the dislocation density and the recrystallization fraction, the method can provide key information for early diagnosis and effective management of the creep damage.

In this embodiment, by establishing the correlation between multiple microstructures (such as the precipitate size, the grain size and the dislocation density) and the service life, the effect of improving the creep damage prediction model is achieved. The prediction model allows for the formation of a regular inspection plan based on prediction results of the model to identify and address a potential damage in a timely manner. The maintenance and replacement plan can be optimized according to the results of the prediction model to avoid premature or late maintenance activities, thereby saving costs and reducing downtime.

In this embodiment, the creep damage diagnosis method provides important improvements for maintenance and life management of industrial materials by providing more comprehensive and accurate damage analysis and earlier damage identification. These advantages stem from its comprehensive and in-depth microstructure analysis method, making it an indispensable tool in industrial application. The method extracts the mean value of characteristic quantities around a rupture region to obtain a more informative result. The quantitative assessment of the creep damage at the rupture position is of great significance for reducing accidents and ensuring long-term operation of devices in the power plant.

### Embodiment 2

This embodiment provides a system for quantitatively diagnosing a creep damage and evaluating a service life of a dissimilar steel welded joint, which is a system corresponding to the method for quantitatively diagnosing a creep damage and evaluating a service life of a dissimilar steel welded joint in Embodiment 1. The system includes a first experimental data acquisition module, a first quantitative characteristic parameter acquisition module, a second experimental data acquisition module, a second quantitative characteristic parameter acquisition module and a diagnosis module.

The first experimental data acquisition module is configured to acquire first experimental data of the dissimilar steel welded joint. The first experimental data are creep rupture images after a creep rupture occurs when an accelerated creep rupture experiment is carried out on the dissimilar steel welded joint, and the creep rupture images include a tissue aging image and a precipitate image.

The first quantitative characteristic parameter acquisition module is configured to quantitatively process the first experimental data to obtain a first quantitative characteristic parameters. The first quantitative characteristic parameters include a hole size, a volume fraction, and a precipitate size in the creep rupture image.

The second experimental data acquisition module is configured to acquire second experimental data of the dissimilar steel welded joint. The second experimental data are EBSD experimental data obtained by performing an EBSD experiment after the creep rupture of the dissimilar steel welded joint.

The second quantitative characteristic parameter acquisition module is configured to quantitatively process the second experimental data to obtain second quantitative characteristic parameters. The second quantitative characteristic parameters include a grain size, a geometric dislocation density, a grain boundary angle, a recrystallization fraction, a recovered grain ratio, and a deformed grain ratio.

The diagnosis module is configured to determine a current life stage and remaining creep life of the dissimilar steel welded joint based on the first quantitative characteristic parameters and the second quantitative characteristic parameters.

In this embodiment, the system further includes: a replacement condition determination module, a replacement module, a maintenance condition determination module and a maintenance module.

The replacement condition determination module is configured to determine whether a replacement condition is met according to the remaining creep life of the dissimilar steel welded joint.

The replacement module is configured to replace the dissimilar steel welded joint in response to that the replacement condition is met.

The maintenance condition determination module is configured to determine whether a maintenance condition is met in response to that the replacement condition is not met; and

The maintenance module is configured to conduct maintenance measures to the dissimilar steel welded joint in response to that the maintenance condition is met.

It should be noted that object information (including but not limited to object device information, object personal information, etc.) and data (including but not limited to data for analysis, data for storage, data for display, etc.) involved in the present disclosure are both information and data authorized by an object or duly authorized by all parties, and the collection, use and processing of the relevant data need to comply with relevant laws, regulations and standards of relevant countries and regions.

The technical features of the above embodiments may be combined arbitrarily. To make the description concise, all possible combinations of the technical features in the above embodiments are not described. However, these combinations should be considered to be within the scope of the description of the present disclosure as long as there is no contradiction in the combinations of these technical features.

In the text, the principle and embodiments of the present disclosure are described herein by using specific examples, the above descriptions of the embodiments are merely intended to help understand the methods and core idea of the present disclosure. In addition, for those of ordinary skill in the art, changes may be made to the specific embodiments and the scope of application according to the concept of the present disclosure. In summary, the content of the description should not be construed as a limitation to the present disclosure.

What is claimed is:

1. A method for quantitatively diagnosing a creep damage and evaluating a service life of a dissimilar steel welded joint, comprising:
acquiring first experimental data of the dissimilar steel welded joint; the first experimental data being creep rupture images after a creep rupture occurs when an accelerated creep rupture experiment is carried out on the dissimilar steel welded joint, and the creep rupture images comprising a tissue aging image and a precipitate image;
quantitatively processing the first experimental data to obtain first quantitative characteristic parameters; the first quantitative characteristic parameters comprising a hole size, a volume fraction, and a precipitate size in the creep rupture image;
acquiring second experimental data of the dissimilar steel welded joint; the second experimental data being electron back scatter diffraction (EBSD) experimental data obtained by performing an EBSD experiment after the creep rupture of the dissimilar steel welded joint;
quantitatively processing the second experimental data to obtain second quantitative characteristic parameters; the second quantitative characteristic parameters comprising a grain size, a geometric dislocation density, a grain boundary angle, a recrystallization fraction, a recovered grain ratio, and a deformed grain ratio;
determining a current life stage and a remaining creep life of the dissimilar steel welded joint based on the first quantitative characteristic parameters and the second quantitative characteristic parameters;
determining whether a replacement condition is met according to the remaining creep life of the dissimilar steel welded joint;
replacing the dissimilar steel welded joint in response to that the replacement condition is met;
determining whether a maintenance condition is met in response to that the replacement condition is not met; and
conducting maintenance measures to the dissimilar steel welded joint in response to that the maintenance condition is met.

2. The method for quantitative diagnosing the creep damage and evaluating the service life of the dissimilar steel welded joint according to claim 1, wherein acquiring the first experimental data of the dissimilar steel welded joint comprises:
carrying out the accelerated creep rupture experiment based on the dissimilar steel welded joint to obtain a creep rupture sample;
observing the creep rupture sample using an optical microscope, and outputting the tissue aging image of the creep rupture sample; and
observing the creep rupture sample using a scanning electron microscope, and outputting the precipitate image of the creep rupture sample.

3. The method for quantitatively diagnosing the creep damage and evaluating the service life of the dissimilar steel welded joint according to claim 2, wherein prior to observing the creep rupture sample using the optical microscope, and outputting the tissue aging image of the creep rupture sample, the method further comprises:
sanding and polishing a sample surface in a creep rupture region of the creep rupture sample to obtain a sanded and polished creep rupture sample;
placing the sanded and polished creep rupture sample in an erosion solution for erosion to obtain an eroded creep rupture sample; and
rinsing and then drying the eroded creep rupture sample to obtain a rinsed creep rupture sample, the rinsed creep rupture sample being used as the creep rupture sample observed by the optical microscope and the scanning electron microscope.

4. The method for quantitatively diagnosing the creep damage and evaluating the service life of the dissimilar steel welded joint according to claim 1, wherein prior to quantitatively processing the first experimental data to obtain the first quantitative characteristic parameters, the method further comprises:
performing automatic threshold segmentation processing, edge detection processing, and image denoising processing on the creep rupture images sequentially by using Image-J software to obtain preprocessed creep rupture images as the first experimental data.

5. The method for quantitatively diagnosing the creep damage and evaluating the service life of the dissimilar steel welded joint according to claim 1, wherein quantitatively processing the first experimental data to obtain the first quantitative characteristic parameters comprises:
determining a size and a volume fraction of each hole in the tissue aging image by using Image-J software;
determining a type of each precipitate in the precipitate image according to the precipitate image; and
determining a size of each type of precipitate in the precipitate image by using the Image-J software.

6. The method for quantitatively diagnosing the creep damage and evaluating the service life of the dissimilar steel welded joint according to claim 1, wherein quantitatively processing the second experimental data to obtain the second quantitative characteristic parameters comprises:
importing the EBSD experimental data into Channel 5 software, and outputting the grain size, the geometric dislocation density, the grain boundary angle, the recrystallization fraction, the recovered grain ratio, and the deformed grain ratio corresponding to the EBSD experimental data by using the Channel 5 software.

7. The method for quantitatively diagnosing the creep damage and evaluating the service life of the dissimilar steel welded joint according to claim 2, wherein prior to acquiring the second experimental data of the dissimilar steel welded joint, the method further comprises:
sanding a sample surface of the creep rupture sample to obtain a sanded creep rupture sample; and
electropolishing the sanded sample surface of the creep rupture sample to obtain an electropolished creep rupture sample as the creep rupture sample for the EBSD experiment.

8. The method for quantitatively diagnosing the creep damage and evaluating the service life of the dissimilar steel welded joint according to claim 1, wherein determining the current life stage and the remaining creep life of the dissimilar steel welded joint based on the first quantitative characteristic parameters and the second quantitative characteristic parameters comprises:
establishing a relation curve between a characteristic parameter and creep life loss of the dissimilar steel welded joint based on the first quantitative characteristic parameters and the second quantitative characteristic parameters; and
determining a current life stage and remaining creep life of the dissimilar steel welded joint based on the relation curve between the characteristic parameter and the creep life loss of the dissimilar steel welded joint.

9. The method for quantitatively diagnosing the creep damage and evaluating the service life of the dissimilar steel welded joint according to claim 1, wherein the replacement condition is that the remaining creep life of the dissimilar steel welded joint is less than or equal to a first remaining life threshold, and the maintenance condition is that the remaining creep life of the dissimilar steel welded joint is greater than the first remaining life threshold and less than or equal to a second remaining life threshold; wherein the first remaining life threshold is less than the second remaining life threshold.

10. The method for quantitatively diagnosing the creep damage and evaluating the service life of the dissimilar steel welded joint according to claim 1, wherein the maintenance measures comprise:
ensuring that an operating pressure of the dissimilar steel welded joint does not exceed a preset pressure and an operating temperature of the dissimilar steel welded joint does not exceed a preset temperature; and
shortening an inspection cycle of the dissimilar steel welded joint, and performing periodic inspections on the dissimilar steel welded joint with the shortened inspection cycle; wherein the periodic inspections comprise at least one of nondestructive testing and tube cutting performance test, the tube cutting performance test comprises at least one of metallographic structure examination and mechanics performance testing.

11. A system for quantitatively diagnosing a creep damage and evaluating a service life of a dissimilar steel welded joint, comprising:
a first experimental data acquisition module configured to acquire first experimental data of the dissimilar steel welded joint; the first experimental data being creep rupture images after a creep rupture occurs when an accelerated creep rupture experiment is carried out on the dissimilar steel welded joint, and the creep rupture images comprising a tissue aging image and a precipitate image;
a first quantitative characteristic parameter acquisition module configured to quantitatively process the first experimental data to obtain first quantitative characteristic parameters; the first quantitative characteristic parameter comprising a hole size, a volume fraction, and a precipitate size in the creep rupture image;
a second experimental data acquisition module configured to acquire second experimental data of the dissimilar steel welded joint; the second experimental data being electron back scatter diffraction (EBSD) experimental data obtained by performing an EBSD experiment after the creep rupture of the dissimilar steel welded joint;
a second quantitative characteristic parameter acquisition module configured to quantitatively process the second experimental data to obtain second quantitative characteristic parameters; and the second quantitative characteristic parameters comprising a grain size, a geometric dislocation density, a grain boundary angle, a recrystallization fraction, a recovered grain ratio, and a deformed grain ratio;
a diagnosis module configured to determine a current life stage and remaining creep life of the dissimilar steel welded joint based on the first quantitative characteristic parameters and the second quantitative characteristic parameters;
a replacement condition determination module configured to determine whether a replacement condition is met according to the remaining creep life of the dissimilar steel welded joint;
a replacement module configured to replace the dissimilar steel welded joint in response to that the replacement condition is met;
a maintenance condition determination module configured to determine whether a maintenance condition is met in response to that the replacement condition is not met; and
a maintenance module configured to conduct maintenance measures to the dissimilar steel welded joint in response to that the maintenance condition is met.
